(19) United States
(12) Patent Application Publication
(10) Pub. No.: US 2016/0136513 A1
(43) Pub. Date: May 19, 2016

(54) METHOD FOR INCREASING A WAGER DURING A BLACKJACK CARD GAME

(71) Applicant: David H. Pang, Rowland Heights, CA (US)

(72) Inventor: David H. Pang, Rowland Heights, CA (US)

(21) Appl. No.: 14/940,054

(22) Filed: Nov. 12, 2015

Related U.S. Application Data
(60) Provisional application No. 62/080,219, filed on Nov. 14, 2014.

(51) Int. Cl. A63F 1/00; G07F 17/32

(52) U.S. Cl. CPC A63F 1/00; G07F 17/3293; G07F 17/3262; A63F 2001/003

(57) ABSTRACT

A method for increasing a wager during a blackjack card game allows a player to at least double the wager after receiving at least one Ace card in an initial card distribution; wherein the increased wager is supplied from a dealer if the at least one Ace card substantially matches another card from the initial card distribution; wherein the increased wager is supplied by the player if the at least one Ace card does not match another card from the initial card distribution. The comparative card game includes black jack. The player can double down on the initial wager if one of the two cards in the initial deal is an Ace card. If the color or suit of the Ace card matches the second card in the initial deal, the player can use house money to double down; otherwise the player must use other funds.

### FIELD OF THE INVENTION

The present invention relates generally to a method for increasing a wager during a blackjack card game. More so, a method for increasing a wager during a blackjack card game allows a player to at least double the wager after receiving at least one Ace card in an initial card distribution; wherein the increased wager is supplied from a dealer if the at least one Ace card substantially matches another card from the initial card distribution; wherein the increased wager is supplied by the player if the at least one Ace card does not match another card from the initial card distribution.

### BACKGROUND OF THE INVENTION

The present invention relates generally to a method for increasing a wager during a comparative card game, such as blackjack. More so, a method for increasing a wager during a comparative card game allows a player to at least double the wager after receiving at least one Ace card in an initial card distribution; wherein the increased wager is supplied from a dealer if the at least one Ace card substantially matches another card from the initial card distribution; wherein the increased wager is supplied by the player if the at least one Ace card does not match another card from the initial card distribution. The comparative card game includes black jack.

It is known that card games and other games of chance have been a prominent cultural phenomenon for many years. From neighborhood card rooms to large casinos, gambling enterprises offering organized card games attract millions of players and generate billions of dollars a year in revenue.

Generally, the card came of blackjack is a comparing card game between a player and dealer. The players compete against the dealer but not against any other players. Blackjack is played with one or more decks of 52 cards. The object of the game is to reach 21 points or to reach a score higher than the dealer without exceeding 21.

In common variations of blackjack, the players are dealt an initial two card hand and add the total of their cards. Face cards, such as, Kings, Queens, and Jacks are counted as ten points. The player and dealer can count an Ace card as 1-point or 11 points. All other cards are counted as the numeric value shown on the card. After receiving their initial two cards, players have the option of getting a “hit,” which means taking an additional card, or siting with the card they already have.

The object of blackjack is to beat the dealer in one of the following ways: a) Obtain 21 points on the player's first two cards without a dealer blackjack; b) Reach a final score higher than the dealer without exceeding 21; or c) Let the dealer draw additional cards until the hand exceeds 21.

Often, a wager, or gamble in cards, is an agreement under which each player pledges a certain amount to the other depending on the outcome of an unsettled matter, such as a card total. Typically, the wager can be large or small. The wager can be against the house or may include a side wager with other players.

Generally, the primary difference between a standard game and a gambling game is the wager, and wagering methods largely define the appeal of a gambling game. Many of the most common casino games have been popular for centuries, and for the most part, the wagering methods used to gamble on the results of the games are equally as hallowed. By offering a new method of wagering, the excitement of existing games may be enhanced, and players will be further attracted to play.

However, the wager distribution in these games does not allow the player to win more than the amount the player bet on a given bet except where the odds are prohibitive against the player winning. In blackjack, where players have close to equal odds of winning, players only have the opportunity to win as much as the amount of their bet, except on rare blackjack hands. This limits the wagering opportunities and excitement of the card game.

It is also recognized that the advent of the Internet has added a new dimension to multi-player card games. The ability to meet and interact with people remotely has enabled the development of online card games, in which several people in remote parts of the world can participate in the same hand of a card game with a networked computer system. Many companies have emerged that provide increasingly sophisticated services to facilitate online card games. Some involve simulated winnings and allow players to compete purely for sport, not money. Others operate as online casinos or card rooms, offering accounts that players can transfer funds to, receive winnings in, and draw upon to place wagers and cover their losses.

Often, online card game systems simulate the structure, rules, and fundamental elements of real-life card games, such as a game room. For example, many online systems retain the concept of a table, wherein each table corresponds to a specific type of game, e.g. poker, blackjack, baccarat.

Other proposals have involved wagering means for comparative card games. The problem with these comparative games is that they don't allow the players to at least double the wager, and they are not applicable with blackjack. Even though the above cited wagering games meet some of the needs of the market, a method and comparative card game for increasing a wager while playing the comparative card game allows a player to at least double an initial wager after receiving at least one Ace card in an initial card distribution is still desired.

### SUMMARY OF THE INVENTION

The present invention is directed to a method for increasing a wager during a blackjack card game allows a player to at least double the wager after receiving at least one Ace card in an initial card distribution. The increased wager is supplied from a dealer if the at least one Ace card substantially matches another card from the initial card distribution. However, if the at least one Ace card does not match another card from the initial card distribution, the increased wager is supplied by the player. The player can double down on the initial wager if one of the two cards in the initial deal is an Ace card. If the color or suit of the Ace card matches the second card in the initial deal, the player can use house money to double down; otherwise the player must use other funds. The comparative card game can be the game of blackjack.

In one embodiment, the method for increasing a wager during a comparative card game provides a unique competitive card game, such as blackjack, that enables players to increase their wagering options. The method may include an initial Step of providing, by a dealer, at least one deck of playing cards. A subsequent Step comprises requiring a player to place an initial wager before cards are dealt.

In another embodiment, the method comprises the Step of dealing out at least two cards to the player and at least one card to the dealer, thereby forming an initial card distribution. This initial card distribution comprises a dealer's initial hand and a player's initial hand. A following Step may include determining if the player's initial hand comprises at least one Ace card. In some embodiments, if the player's initial hand comprises at least one Ace card, the player may at least double the initial wager. It is also significant to note that enabling the player to at least double the initial wager is doubling down on the initial wager.

From here, a Step includes enabling the player to bet the increased wager with funds from the dealer if the at least one Ace card substantially matches an additional card from the player's initial hand. The Ace card substantially matching the additional card from the player's initial hand may include a card with a matching color or suit. Additionally, a Step comprise enabling the player to bet the increased wager with funds from the player if the at least one Ace card substantially matches an additional card from the player's initial hand.

A final Step comprises determining whether the player's initial hand and the dealer's initial hand matches or approaches a predetermined value, wherein the player and the dealer draw cards from additional deals until the player or the dealer match or approach the predetermined value without exceeding the predetermined value. In one embodiment, the predetermined value is 21, wherein the player or dealer attempt to match 21 or approach 21 without exceeding the predetermined value of 21.

One objective of the present invention is to increase the wagering opportunities in a card game.

Another objective is to provide an opportunity to double down during the comparative card game.

Another objective is to provide an opportunity to double down on a wager without requiring the player to take an additional card and stand.

Another objective is to help a skilled player receive benefits of doubling down when the dealer has a poor initial hand, such as a 4, 5, 6, or 7 card.

Yet another objective is to provide a new method of wagering; thereby enhancing the excitement of existing games so that players will be further attracted to play.

Yet another objective is to provide an online means for wagering a blackjack game.

Yet another objective is to provide cost effective and convenient wagering capability to blackjack.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a flowchart diagram of an exemplary a method for increasing a wager during a comparative card game, in accordance with an embodiment of the present invention;

FIG. 2 illustrates an initial deal of an Ace card having a Spades suit, and a King card having a Spades suit, in accordance with an embodiment of the present invention;

FIG. 3 illustrates a perspective view of an exemplary comparative card game where a player receives an initial hand comprising an Ace card, in accordance with an embodiment of the present invention; and

FIG. 4 is a block diagram depicting an exemplary client/server system which may be used by an exemplary web-enabled/networked embodiment for the method 100 for wagering a comparative card game.

Like reference numerals refer to like parts throughout the various views of the drawings.

### DETAILED DESCRIPTION OF THE INVENTION

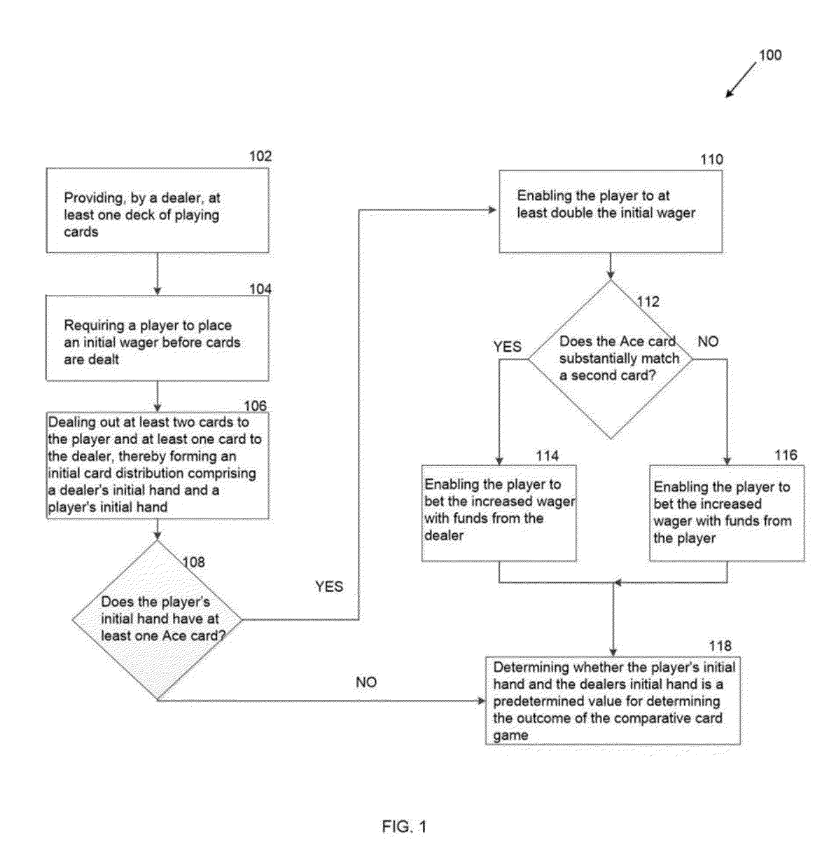

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “first,” “second,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

At the outset, it should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of this invention as required by 35 U.S.C. §112.

In one embodiment of the present invention presented in FIGS. 1-4, a method 100 and blackjack card game 200 for increasing a wager 210 while playing the blackjack card game 200 allows a player 202 to at least double an initial wager 210 after receiving at least one Ace card 206 in an initial card distribution. If the Ace card 206 substantially matches an additional card 208 from the initial card distribution, the player has the option of betting the increased wager 210 from the dealer 204, i.e., house money.

Otherwise, if the Ace card 206 does not match the additional card 208 from the initial card distribution, the increased wager 210 may be supplied by the player 202. However, if the initial card distribution does not include an Ace card 206, the comparative card game 200 proceeds without the option of increasing the wager 210.

Those skilled in the art will recognize that the player 202 is generally allowed to increase the initial wager 210 by up to 100%, i.e., double down, in exchange for committing to stand after receiving one more card beyond the initial card distribution. The present invention enables the player 202 to double down without having to commit to only receiving one more card and then standing. This greater flexibility in allowing the player 202 to double down can be advantageous for the player 202, especially in circumstances where the dealer 204 has an initially poor card, such as a 4, 5, 6, or 7 card.

In some embodiments, the comparative card game 200 may include, without limitation, black jack or a black jack style card game. The method 100 may be applied at a gambling table, a video console, or a computer. The initial card distribution may include two cards out of a deck of 52 cards. Though in some embodiments, more than one deck of cards may be used to produce the two cards for the initial card distribution.

In one embodiment, where the comparative card game 200 is black jack, the player 202 has the option of increasing the wager 210 if at least one Ace card 206 is received in the initial two card distribution. This may include an initial card distribution of: a soft 2 comprising of two Ace cards 206; a soft 21 comprising of one Ace card 206 and a face card; or a soft comprising of an Ace and a number card. In any case, an initial Ace card 206 must be received in the initial card distribution to increase the wager 210.

In some embodiments, the player 202 has the option of at least doubling the wager 210 with dealer funds if the Ace card 206 substantially matches the additional card 208 in the initial distribution. The substantial match may include, without limitation, having the same suit or the same color. Conversely, the player 202 has the option of at least doubling the wager 210 with the player's 202 own funds if the Ace card 206 does not substantially match the additional card 208 from the initial distribution. Thus, having the same suit or color for the initial two cards, with one of the cards being an Ace card 206 allows the player 202 to double down.

For example, without limitation, a player 202 who is dealt a red Ace of Hearts and a red Queen of Diamonds enables the player 202 to double down with house money. However, being dealt a red Ace of Diamonds and a black Jack of Clubs, requires the player 202 to use player money if the player 202 decides to double down. After the player 202 doubles down, the comparative card game 200 may proceed through standard rules known in the art.

There is an exception to the above circumstance for increasing the wager 210, however. The ability to increase the wager 210 is possible as explained, except when the player 202 splits the hand, and thus has two different games running simultaneously. In this instance, the wager 210 is not increased until a new second card is dealt for the new first game and the new second game.

For example, if the player 202 receives two Ace cards 206, the player 202 may split the Ace cards 206 into two different games 200. The dealer 204 at this point will deal one more card to the first game, and the player 202 may then proceed by requesting more cards, standing, or increasing the wager 210, i.e., doubling down, if possible. After the first game is complete, the dealer 204 deals another card for the second game, and the player 202 proceeds as in the first game. So in essence, when the player 202 splits the hand, the initial wager 210 increase may be delayed or prohibited, depending on the new cards for the new split games.

FIG. 1 references a method 100 for increasing a wager 210 during a comparative card game 200. The method 100 allows a player 202 to at least double the wager 210 in the middle of the comparative card game 200. In some embodiments, the player 202 may increase the wager 210 after receiving at least one Ace card 206 in an initial card distribution. However, if no Ace card 206 is received, the method 100 is generally not applicable. It is significant to note that increasing the wage, i.e., doubling down, may be advantageous in certain circumstances, such as when the dealer 204 has a poor initial hand or the player 202 is skilled.

If the Ace card 206 substantially matches an additional card 208 from the initial card distribution, the increased wager 210 may be supplied from a dealer 204, i.e., house money. Otherwise, if the at least one Ace card 206 does not match the additional card 208 from the initial card distribution, the increased wager 210 may be supplied by the player 202—if the player 202 chooses to double down. Using player money may be less advantageous than using house money, but still provides the player the opportunity to do so. Nonetheless, if the initial card distribution does not include an Ace card 206, the comparative card game 200 proceeds without the option of increasing the wager 210.

As referenced in FIG. 1, the method 100 comprises an initial Step 102 of providing, by a dealer 204, at least one deck of playing cards. The comparative card game 200 may include blackjack, which is played between a dealer 204 and at least one player 202 at a physical gaming table or video console, according to the predetermined rules of blackjack card games. The rules may require utilizing playing cards where all face cards count ten, aces count one or eleven, and all other cards count their face value. Each player 202 makes an initial wager 210 and the dealer 204 randomly distributes an initial player 202 hand of two cards to each player 202 and at least one card to the dealer 204.

A Step 104 may include requiring a player 202 to place an initial wager 210 before cards are dealt. The wager 210 may include wagering chips, cash, or objects having some value. The limits for the initial wager 210 are determined by the dealer 204 or the house. Those skilled in the art will recognize that minimum and maximum wagers are typically posted on the betting table. The payoff on most bets is typically 1:1, meaning that the player wins the same amount as he bets. The payoff for a player in black jack is typically 3:2, meaning that the casino pays $3 for each $2 originally bet.

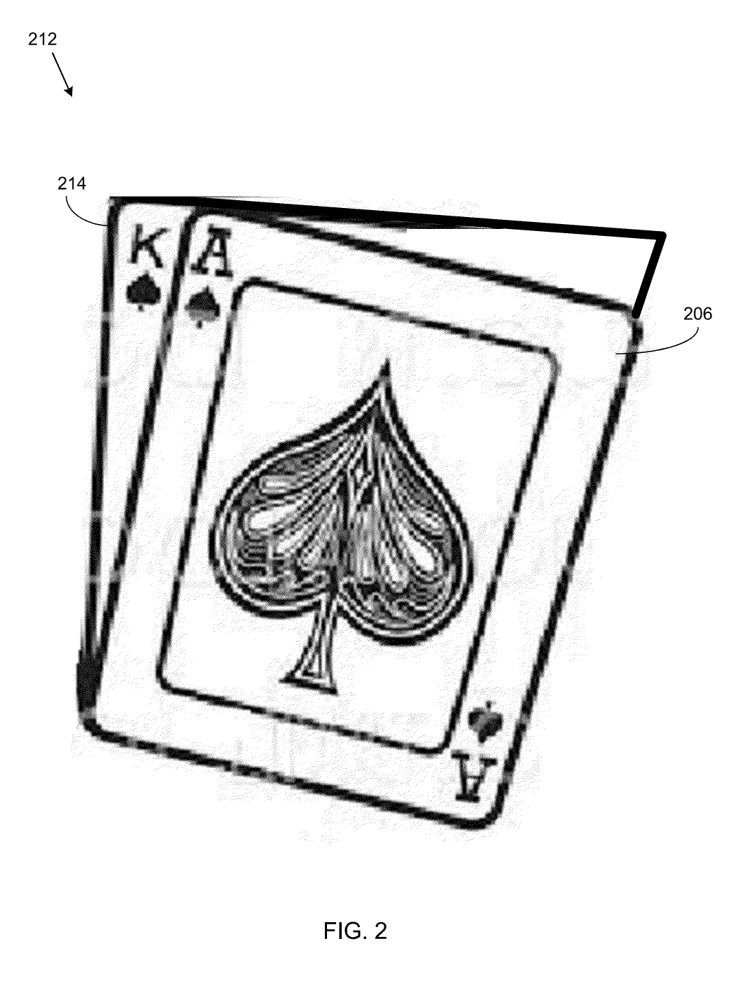

A Step 106 comprises dealing out at least two cards to the player 202 and at least one card to the dealer 204, thereby forming an initial card distribution, the initial card distribution comprising a dealer's 204 initial hand and a player's 202 initial hand. In one embodiment, the player 202 receives two cards. FIG. 2 illustrates an initial deal 212 of an Ace card 206 having a Spades suit, and a King card 214 having a Spades suit.

In some embodiments, a Step 108 may include determining if the player's 202 initial hand comprises at least one Ace card 206. This is the case in FIG. 2, as one of the cards from the initial deal 212 is an Ace card 206 having a Spades suit. Thus, if the Ace card 206 is received from the initial two card distribution, the player 202 has the option of increasing the wager 210.

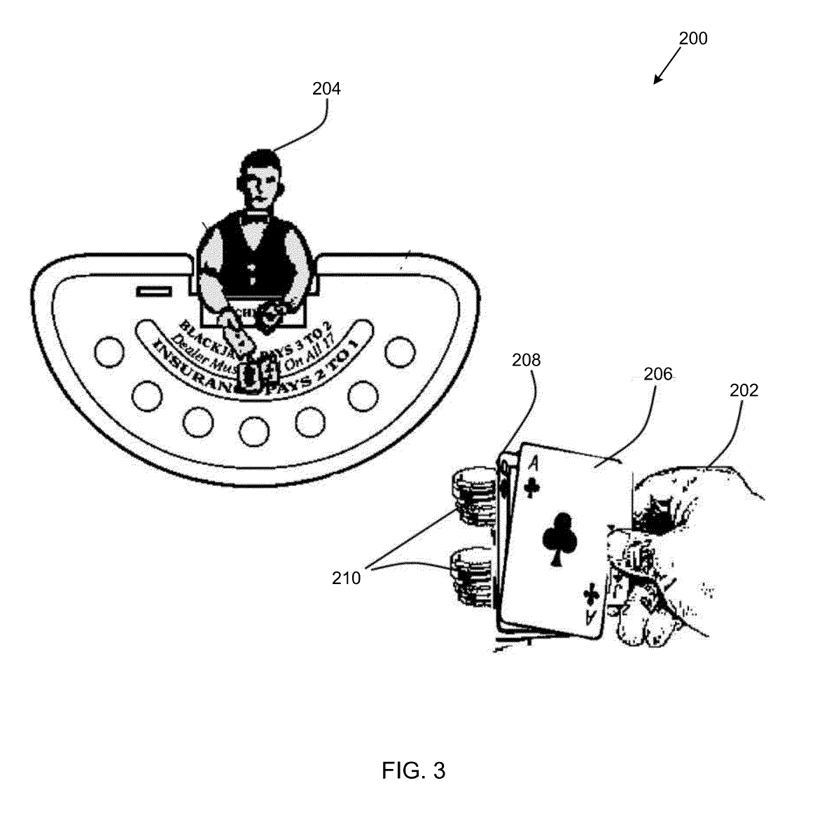

This scenario of an initial deal 212 may include an initial card distributions of: a soft 2 comprising of two Ace card 206; a soft 21 comprising of one Ace card 206 and a face card (FIG. 3); and a soft comprising of an Ace card 206 and a number card. In any case, an initial Ace card 206 must be received in the initial card distribution. However, as explained above, if the player 202 splits the hand, the initial wager 210 increase may be delayed or prohibited, depending on the new cards for the new split games.

If the player's 202 initial hand comprises at least one Ace card 206, a Step 110 comprises enabling the player 202 to at least double the initial wager 210. Generally, when doubling down, the player is allowed to increase the initial wager 210 by up to 100%. At a gambling table, the additional wager may placed in the betting box next to the initial wager 210. Doubling down enables the player 102 to substantially increase the winnings.

For example, the player 202 initially bets a $100 wager 210, and the dealer 204 matches with another $100. At that point, if the player 202 wins, then the player 202 receives $200. However, if the player 202 doubles down with house money of $100, the dealer 204 matches with an additional $100, and there would be $200 in the betting box. If the player 202 wins, the player receives $200, with $100 of that coming from the house.

A Step 114 includes enabling the player 202 to bet the increased wager 210 with funds from the dealer 204, i.e., house money, if the at least one Ace card 206 substantially matches an additional card 208 from the player's 202 initial hand. The substantial match may include, without limitation, having the same suit or the same color. The funds from the dealer 204 may include house money. FIG. 2 would be such an example, as the initial deal 212 of an Ace card 206 having a Spades suit, and a King card 214 having a Spades suit. The Spades are a substantial match.

A Step 116 includes enabling the player 202 to bet the increased wager 210 with funds from the player 202 if the at least one Ace card 206 substantially matches an additional card 208 from the player's 202 initial hand. The player 202 has the option of at least doubling the wager 210 with the player's 202 own funds if the Ace card 206 does not substantially match the additional card 208 from the initial card distribution.

This scenario of using player money is less advantageous to the player 202 than using house money. However, the option of doubling down may still be favorable to the player 202. For example, without limitation, a red Ace of Spades and a red number card enables the player 202 to double down with house money. A red Ace of Spades and a black Jack of Spades requires player 202 money if the player 202 decides to double down.

A final Step 118 comprises determining whether the player's 202 initial hand and the dealer's 204 initial hand is a predetermined value for determining the outcome of the comparative card game 200. The rules of black jack dictate the winner. In one embodiment, number cards count as their natural value; the jack, queen, and king (also known as “face cards” or “pictures”) count as 10; aces are valued as either 1 or 11 according to the player's 202 choice. If the hand value exceeds 21 points, it busts, and all bets on it are immediately forfeit.

After all players 202 have finished playing, the dealer's 204 hand is resolved by drawing cards until the hand busts or achieves a value of 17 or higher (a dealer 204 total of 17 including an ace, or “soft 17”, must be drawn to in some games and must stand in others). The dealer 204 never doubles, splits, or surrenders. If the dealer 204 busts, all remaining player 202 hands win. If the dealer 204 does not bust, each remaining wager 210 wins if its hand is higher than the dealer's 204, and loses if it is lower.

Those skilled in the art, in light of the present teachings, will recognize that in the case of a tied score, known as “push” or “standoff”, wagers 210 are normally returned without adjustment; however, a black jack beats any hand that is not a black jack, even one with the predetermined value of 21.

Those skilled in the art will recognize that the method 100 may be applied to a digital format, such as on the internet or in a video arcade. This may be especially profitable in an online casinos or card rooms, in which players 202 have accounts that players 202 can transfer funds to, receive winnings in, and draw upon to place wagers and cover their losses. The present method simulates the structure, rules, and fundamental elements of real-life card blackjack game. For example, an online version of the method 100 retains the concept of a table, wherein each table corresponds to a blackjack game. The online version of the method 100 requires processors, servers, and network connections, as described below.

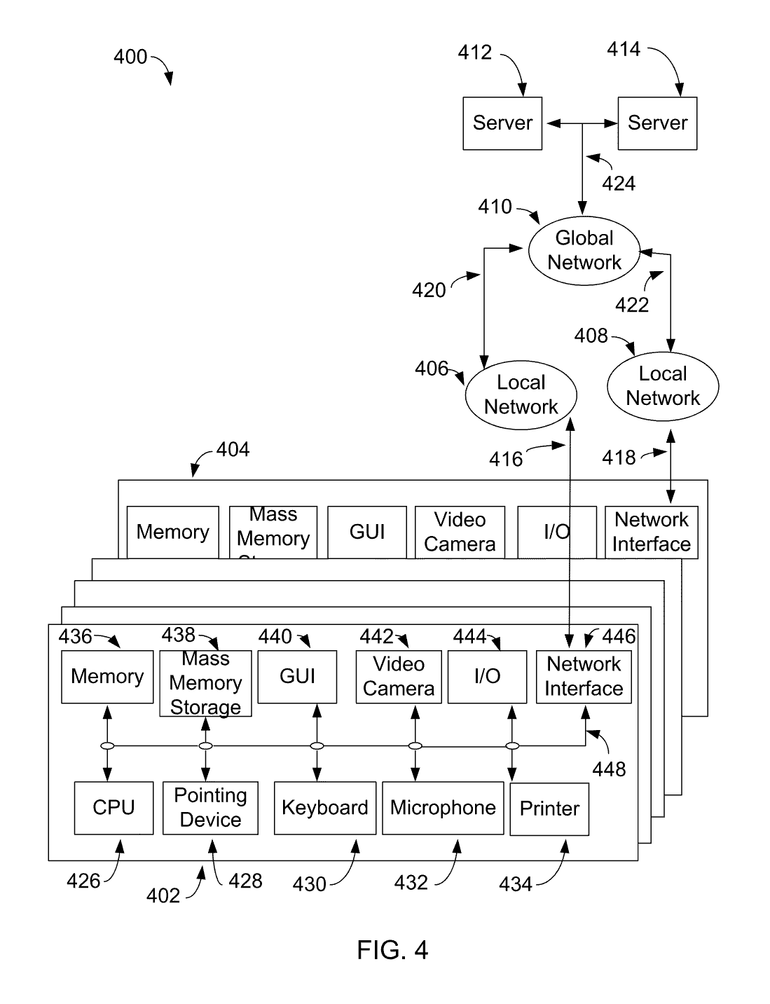

FIG. 4 references a block diagram depicting an exemplary client/server system which may be used by an exemplary web-enabled/networked embodiment for the method 100 for increasing a wager during a comparative card game. In one possible embodiment, the block diagram provides a communication system 400 having a multiplicity of clients with a sampling of clients denoted as a client 402 and a client 404, a multiplicity of local networks with a sampling of networks denoted as a local network 406 and a local network 408, a global network 410 and a multiplicity of servers with a sampling of servers denoted as a server 412 and a server 414.

Client 402 may communicate bi-directionally with local network 406 via a communication channel 416. Client 404 may communicate bi-directionally with local network 408 via a communication channel 418. Local network 406 may communicate bi-directionally with global network 410 via a communication channel 420. Local network 408 may communicate bi-directionally with global network 410 via a communication channel 422. Global network 410 may communicate bi-directionally with server 412 and server 414 via a communication channel 424. Server 412 and server 414 may communicate bi-directionally with each other via communication channel 424. Furthermore, clients 402, 404, local networks 406, 408, global network 410 and servers 412, 414 may each communicate bi-directionally with each other.

In one embodiment, global network 410 may operate as the Internet. It will be understood by those skilled in the art that communication system 400 may take many different forms. Non-limiting examples of forms for communication system 400 include local area networks (LANs), wide area networks (WANs), wired telephone networks, wireless networks, or any other network supporting data communication between respective entities.

Clients 402 and 404 may take many different forms. Non-limiting examples of clients 402 and 404 include personal computers, personal digital assistants (PDAs), cellular phones and smartphones.

Client 402 includes a CPU 426, a pointing device 428, a keyboard 430, a microphone 432, a printer 434, a memory 436, a mass memory storage 438, a GUI 440, a video camera 442, an input/output interface 444 and a network interface 446.

CPU 426, pointing device 428, keyboard 430, microphone 432, printer 434, memory 436, mass memory storage 438, GUI 440, video camera 442, input/output interface 444 and network interface 446 may communicate in a unidirectional manner or a bi-directional manner with each other via a communication channel 448. Communication channel 448 may be configured as a single communication channel or a multiplicity of communication channels.

CPU 426 may be comprised of a single processor or multiple processors. CPU 426 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 436 is used typically to transfer data and instructions to CPU 426 in a bi-directional manner. Memory 436, as discussed previously, may include any suitable computer-readable media, intended for data storage, such as those described above excluding any wired or wireless transmissions unless specifically noted. Mass memory storage 438 may also be coupled bi-directionally to CPU 426 and provides additional data storage capacity and may include any of the computer-readable media described above. Mass memory storage 438 may be used to store programs, data and the like and is typically a secondary storage medium such as a hard disk. It will be appreciated that the information retained within mass memory storage 438, may, in appropriate cases, be incorporated in standard fashion as part of memory 436 as virtual memory.

CPU 426 may be coupled to GUI 440. GUI 440 enables a user to view the operation of computer operating system and software. CPU 426 may be coupled to pointing device 428. Non-limiting examples of pointing device 428 include computer mouse, trackball and touchpad. Pointing device 428 enables a user with the capability to maneuver a computer cursor about the viewing area of GUI 440 and select areas or features in the viewing area of GUI 440. CPU 426 may be coupled to keyboard 430. Keyboard 430 enables a user with the capability to input alphanumeric textual information to CPU 426. CPU 426 may be coupled to microphone 432. Microphone 432 enables audio produced by a user to be recorded, processed and communicated by CPU 426. CPU 426 may be connected to printer 434. Printer 434 enables a user with the capability to print information to a sheet of paper. CPU 426 may be connected to video camera 442. Video camera 442 enables video produced or captured by user to be recorded, processed and communicated by CPU 426.

CPU 426 may also be coupled to input/output interface 444 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 426 optionally may be coupled to network interface 446 which enables communication with an external device such as a database or a computer or telecommunications or internet network using an external connection shown generally as communication channel 416, which may be implemented as a hardwired or wireless communications link using suitable conventional technologies. With such a connection, CPU 426 might receive information from the network, or might output information to a network in the course of performing the method steps described in the teachings of the present invention.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What I claim is:

1. A method for increasing a wager during a comparative card game, the method comprising:
providing, by a dealer, at least one deck of playing cards;
requiring a player to place an initial wager before cards are dealt;
dealing out at least two cards to the player and at least one card to the dealer, thereby forming an initial card distribution, the initial card distribution comprising a dealer's initial hand and a player's initial hand;
determining if the player's initial hand comprises at least one Ace card;
whereby, if the player's initial hand comprises at least one Ace card, enabling the player to at least double the initial wager;
enabling the player to bet the increased wager with funds from the dealer if the at least one Ace card substantially matches an additional card from the player's initial hand;
enabling the player to bet the increased wager with funds from the player if the at least one Ace card substantially matches an additional card from the player's initial hand; and
determining whether the player's initial hand and the dealer's initial hand matches or approaches a predetermined value, wherein the player and the dealer draw cards from additional deals until the player or the dealer match or approach the predetermined value without exceeding the predetermined value.

2. The method of claim 1, wherein the comparative card game is black jack.

3. The method of claim 1, wherein the step of enabling the player to at least double the initial wager further comprises doubling down on the initial wager.

4. The method of claim 1, wherein the step of the Ace card substantially matching an additional card from the player's initial hand further comprises a matching color or suit.

5. The method of claim 1, wherein the predetermined value is 21.

6. The method of claim 1, wherein the step of enabling the player to bet is restricted if the player splits the player's initial hand.

7. One or more computer storage media storing computer-usable instructions, that when used by one or more computing devices, cause the one or more computing devices to perform a method for increasing a wager during a comparative card game comprising the steps of:
(a) providing, by a dealer, at least one deck of playing cards;
(b) requiring a player to place an initial wager before cards are dealt;
(c) dealing out at least two cards to the player and at least one card to the dealer, thereby forming an initial card distribution, the initial card distribution comprising a dealer's initial hand and a player's initial hand;
(d) determining if the player's initial hand comprises at least one Ace card;
(e) whereby if the player's initial hand comprises at least one Ace card, enabling the player to at least double the initial wager;
(f) enabling the player to bet the increased wager with funds from the dealer if the at least one Ace card substantially matches an additional card from the player's initial hand;
(g) enabling the player to bet the increased wager with funds from the player if the at least one Ace card substantially matches an additional card from the player's initial hand; and
(h) determining whether the player's initial hand and the dealer's initial hand matches or approaches a predetermined value, wherein the player and the dealer draw cards from additional deals until the player or the dealer match or approach the predetermined value without exceeding the predetermined value.

8. The method of claim 7, wherein the method is played online.

9. The method of claim 7, wherein the comparative card game is black jack.

10. The method of claim 7, wherein the step of enabling the player to at least double the initial wager further comprises doubling down on the initial wager.

11. The method of claim 7, wherein the step of the Ace card substantially matching an additional card from the player's initial hand further comprises a matching color or suit.

12. The method of claim 7, wherein the predetermined value is 21.

13. The method of claim 7, wherein the step of enabling the player to bet is restricted if the player splits the player's initial hand.

14. A system for increasing a wager during a comparative card game, the method comprising:
means for providing, by a dealer, at least one deck of playing cards;
means for requiring a player to place an initial wager before cards are dealt;
means for dealing out at least two cards to the player and at least one card to the dealer, thereby forming an initial card distribution, the initial card distribution comprising a dealer's initial hand and a player's initial hand;
means for determining if the player's initial hand comprises at least one Ace card;
whereby, if the player's initial hand comprises at least one Ace card, enabling the player to at least double the initial wager;
means for enabling the player to bet the increased wager with funds from the dealer if the at least one Ace card substantially matches an additional card from the player's initial hand;
means for enabling the player to bet the increased wager with funds from the player if the at least one Ace card substantially matches an additional card from the player's initial hand; and
means for determining whether the player's initial hand and the dealer's initial hand matches or approaches a predetermined value, wherein the player and the dealer draw cards from additional deals until the player or the dealer match or approach the predetermined value without exceeding the predetermined value.

15. The system of claim 14, wherein the system is played online.

16. The system of claim 14, wherein the comparative card game is black jack.

17. The system of claim 14, wherein the step of enabling the player to at least double the initial wager further comprises doubling down on the initial wager.

18. The system of claim 14, wherein the step of the Ace card substantially matching an additional card from the player's initial hand further comprises a matching color or suit.

19. The system of claim 14, wherein the predetermined value is 21.

20. The system of claim 14, wherein the step of enabling the player to bet is restricted if the player splits the player's initial hand.
